(19) United States
(12) Patent Application Publication
(10) Pub. No.: US 2005/0093321 A1
(43) Pub. Date: May 5, 2005

(54) OVERHEAD CONSOLE FOR A SPORT UTILITY VEHICLE

(76) Inventors: Roderick J. MacWilliam, Arvada, CO (US); Frank A. Borke, Windsor, CO (US)

Correspondence Address: DORR CARSON SLOAN & BIRNEY, PC, 3010 EAST 6TH AVENUE, DENVER, CO, 80206, US

(21) Appl. No.: 10/699,248

(22) Filed: Oct. 31, 2003

(51) Int. Cl. B60R 7/04

(52) U.S. Cl. 296/24.34

(57) ABSTRACT

An overhead console assembly for a vehicle. The console assembly is mounted to extend in an overhead position between the windshield of the vehicle and a portion of the safety bar arrangement. The console assembly is intended to stay in place whether or not the vehicle has a top. Additionally, the console assembly is designed to be used with any number of conventional hard and soft tops without interfering with their attachment to the vehicle or normal operation.

### BACKGROUND OF THE INVENTION

1. Field of the Invention

This invention relates to the field of overhead consoles for sport utility and similar vehicles and more particularly to such vehicles with tops designed to be removed or lowered.

2. Discussion of the Background

Sport utility vehicles normally have consoles conveniently positioned between the drive and passenger in the cockpit of the vehicle. Such consoles are commonly located between the front seats of the vehicle and/or in an overhead position. All known overhead consoles are integrally attached to the vehicle top and do not remain in place when the top is removed or lowered.

In this light, the present invention was developed. With it, an overhead console is provided that remains in place when the top is removed or lowered. Further, the overhead console is specifically designed to be used with any number of conventional top designs without hindering their normal attachment and operation. Consequently, the overhead console can be used with both hard and soft tops including full tops that enclose the entire interior of the vehicle as well as partial ones that extend over and cover only the cockpit of the vehicle.

### SUMMARY OF THE INVENTION

This invention involves an overhead console assembly for a vehicle. The console assembly is mounted to extend in an overhead position between the windshield of the vehicle and a portion of the safety bar arrangement. The console assembly is intended to remain in place whether or not the vehicle has a top. Additionally, the console assembly is designed to be used with any number of conventional hard and soft tops without interfering with their attachment to the vehicle or normal operation.

The console assembly is elongated and has front and rear end portions spaced from each other along an axis. The front end portion is secured to the upper portion of the vehicle windshield for pivotal movement about a horizontal axis. The rear end portion in the preferred embodiment has a rearwardly facing, open member to straddle the safety bar immediately behind and above the vehicle cockpit. The front and rear end portions in this regard are slidably mounted to each other for relative movement along the axis of the console assembly.

In use, the front end portion of the console assembly is preferably clipped or snapped to the windshield and pivoted to horizontally align the straddling member of the rear end portion with the safety bar. The straddling member of the rear end portion is thereafter slid rearwardly relative to the front end portion to engage the safety bar. A strap arrangement is then provided to secure the straddling member to the safety bar to mount the console assembly in an overhead position above the vehicle cockpit.

The ability of the two end portions of the console assembly to slide relative to each other to change the overall length of the console assembly also enables the console assembly to be adjusted to fit vehicles whose windshields and safety bars may be spaced at different distances from each other. The pivotally mounted front end portion further enables the console assembly of the present invention to be moved to align with vehicles whose windshields and safety bars may be at slightly different vertical levels or heights on the vehicle.

In another embodiment of the invention, a hardtop of two, removable sections is positionable over the vehicle cockpit and the console assembly. The sections preferably have overlapping and interlocking edge portions and each section is preferably at least partially supported by the console assembly.

### BRIEF DESCRIPTION OF THE DRAWINGS

FIG. 1 is a perspective view of a vehicle with the overhead console assembly of the present invention mounted to it.

FIG. 2 is a perspective view of the underside of the console assembly of FIG. 1.

FIG. 3 is a view taken along line 3-3 of FIG. 2 showing one manner in which the rear end portion of the console assembly can be removably secured to the safety bar.

FIG. 4 is a perspective view similar to FIG. 2 but more fully showing the underside of the console assembly.

FIG. 5 is view taken along line 5-5 of FIG. 2 showing one manner in which the front end portion of the console assembly can be removably secured to the vehicle windshield.

FIG. 6 is a view taken along line 6-6 of FIG. 5 showing further details of how the front end portion of the console assembly is clipped or snapped in place to the windshield.

FIGS. 7 and 8 are views similar to FIG. 5 showing the addition of a vehicle soft top that can be positioned over the console assembly (FIG. 7) and latched in place to the windshield (FIG. 8) in its normal manner without any interference from the console assembly.

FIG. 9 illustrates an embodiment of the present invention in which a hardtop with two, removable sections is shown positionable over the console assembly.

FIG. 10 is a view taken along line 10-10 of FIG. 9 illustrating how the sections of the hardtop have overlapping and interlocking parts above the console assembly which are also supported by the console assembly.

FIG. 11 illustrates the console assembly of the present invention in use with a partial soft top that extends only over and covers the vehicle cockpit.

FIG. 12 shows further details of the manner in which the two portions of the console assembly are mounted for sliding movement relative to each other to adjust the overall length of the console assembly.

### DETAILED DESCRIPTION OF THE INVENTION

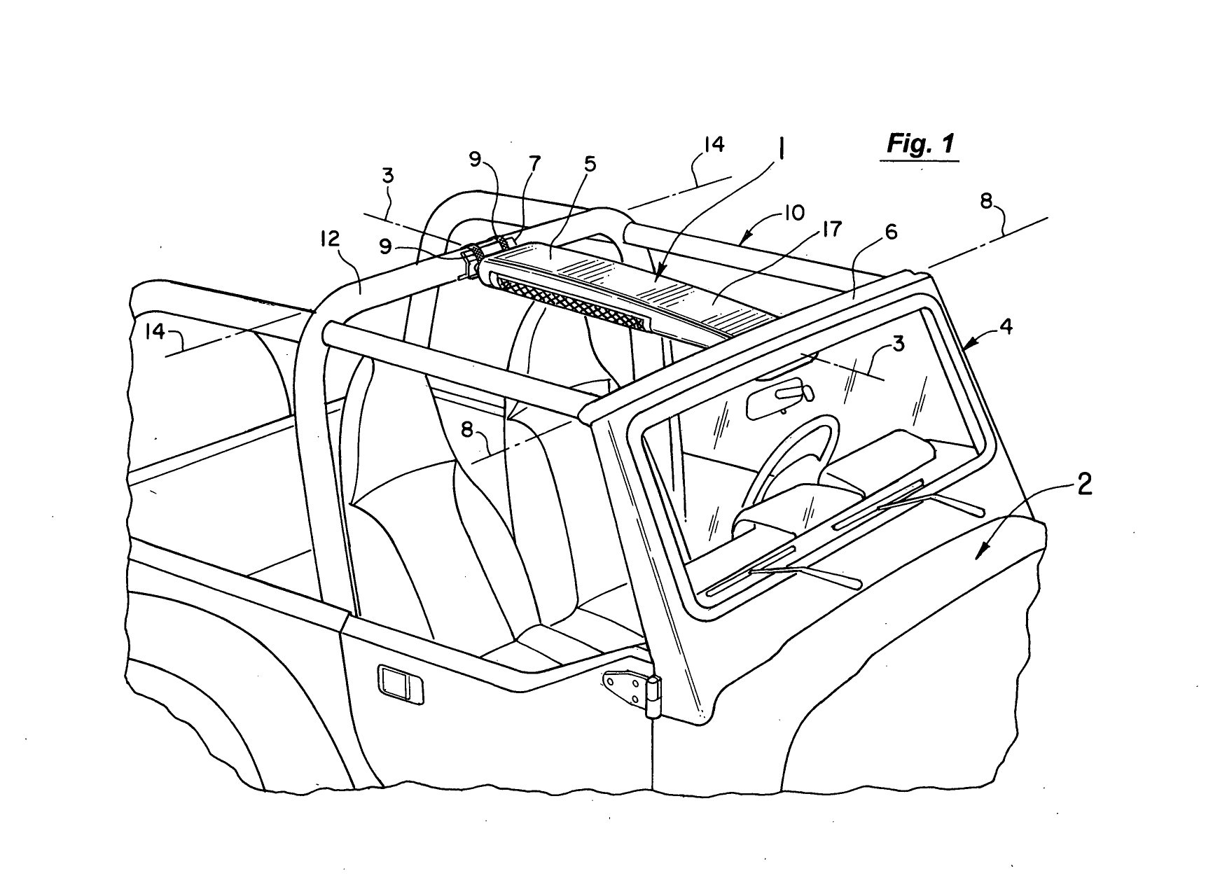

As shown in FIG. 1, the present invention includes an elongated, overhead console assembly 1 for a vehicle 2. The vehicle 2 has a windshield 4 with an upper portion 6 extending substantially horizontally across the vehicle 2 along the axis 8. The vehicle 2 further includes a safety bar arrangement 10 with a portion 12 thereof spaced rearwardly of the upper portion 6 of the windshield 4 and extending substantially horizontally across the vehicle 2 along the axis 14. The elongated console assembly 1 as explained in more detail below is respectively mounted to the upper windshield portion 6 and to the safety bar portion 12 to extend substantially horizontally therebetween along the substantially horizontal axis 3. The upper windshield portion 6 and the safety bar portion 12 in this regard are normally at substantially the same vertical level or height on the vehicle 2.

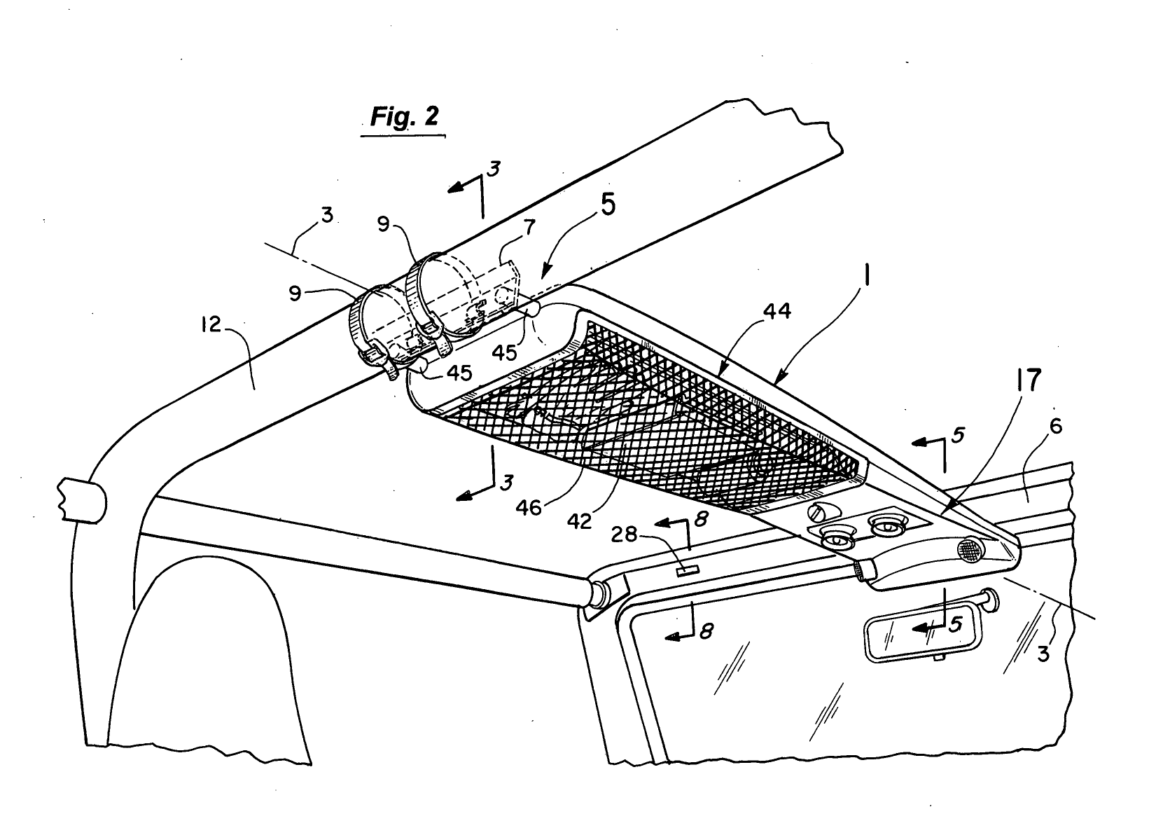

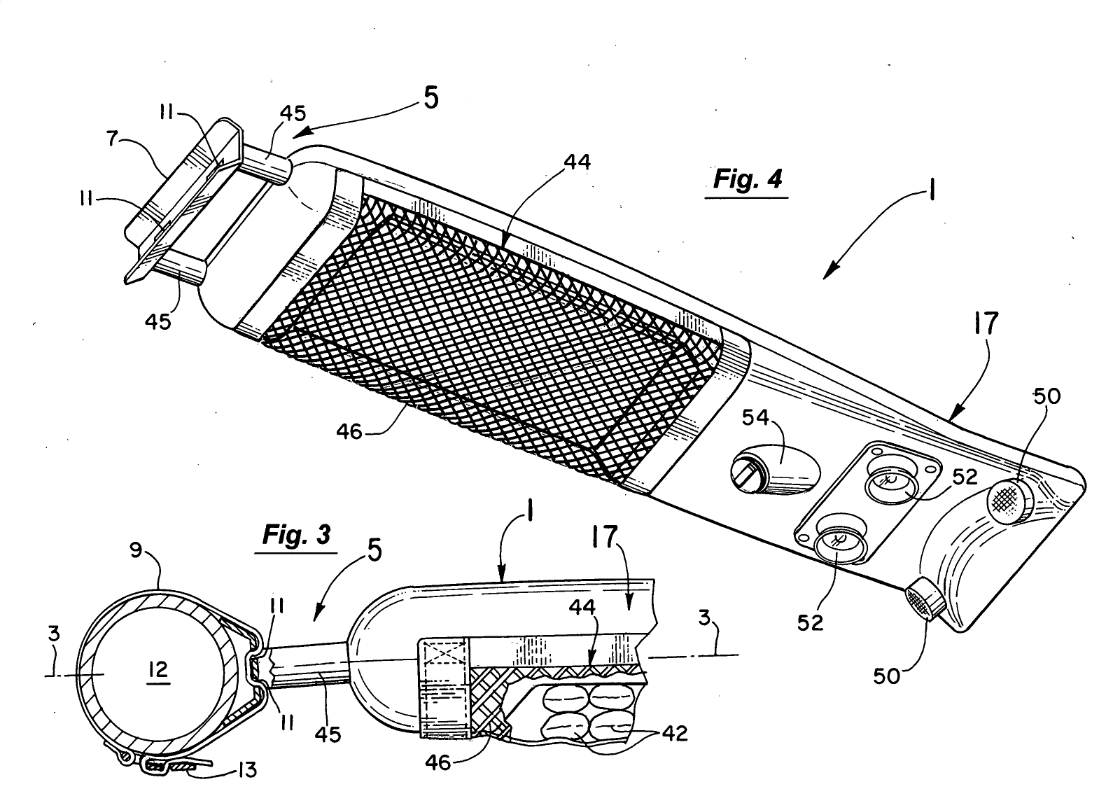

The rear end portion 5 of the overhead console assembly 1 can be secured to the safety bar portion 12 in any number of manners. In the illustrated one of FIGS. 1-3, the rear end portion 5 is provided with a rearwardly facing, open member 7 (see FIGS. 3 and 4) which abuts and straddles the safety bar portion 12 (FIG. 3) and is removably secured in place by a pair of buckled straps 9 (see also FIGS. 1 and 2). The straddling member 7 has two pairs of vertically spaced slots 11 on each end (see again FIG. 3) through which each strap 9 can be respectively threaded and tightened by buckle 13 about the safety bar portion 12. Similarly, the front end portion 17 of the overhead console assembly 1 can be removably secured to the upper windshield portion 6 in a variety of ways. In the illustrated one of FIGS. 2, 5, and 6, a depending footman bracket 12 is attached to the upper windshield portion 6 by horizontally staggered clamp or clip members 21 (see FIG. 6) snapped onto the horizontal rod member 12′ of the footman bracket 12.

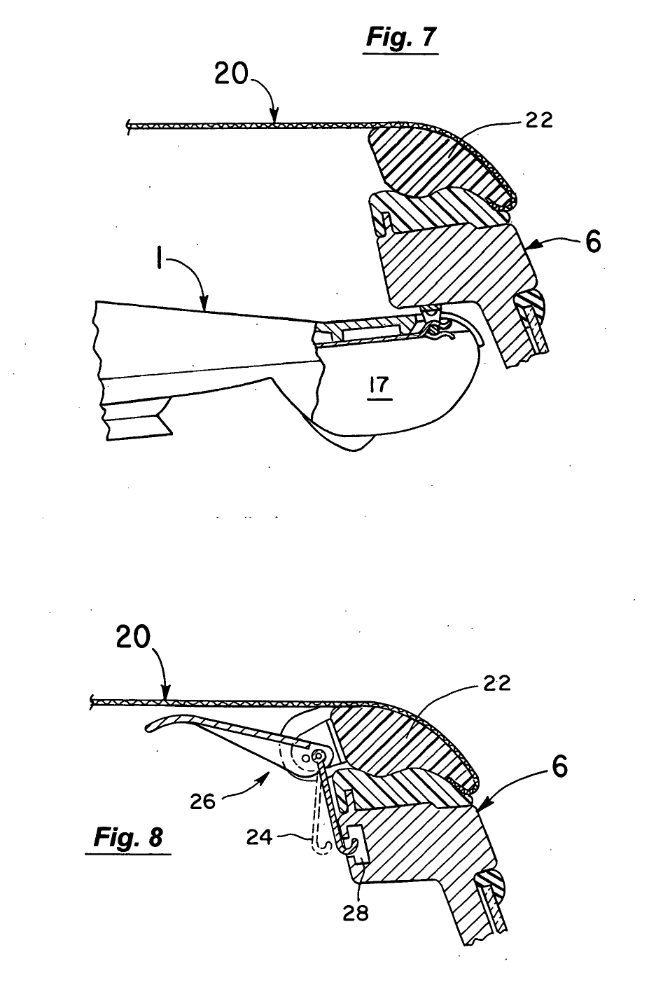

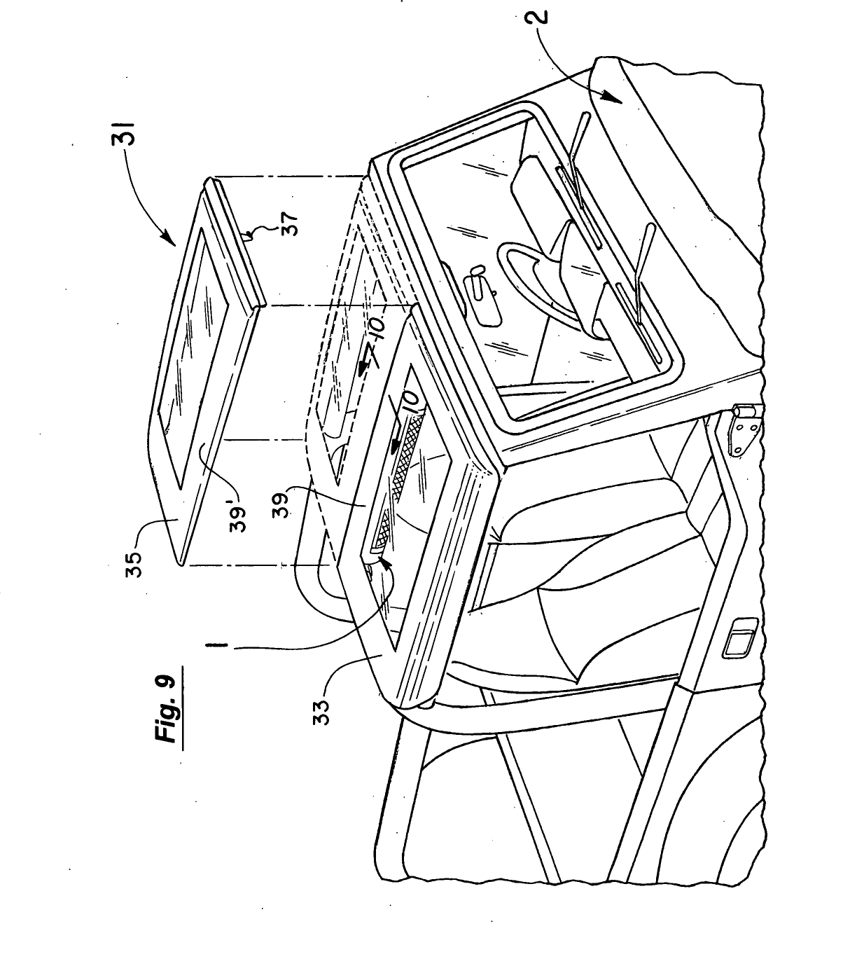

The overhead console assembly 1 as shown in FIGS. 1 and 2 is intended to be mounted to the upper windshield portion 6 and safety bar portion 12 in a secured manner as discussed above. The console assembly 1 is also intended to remain in place whether or not there is a top on the vehicle 2. In doing so, the securing arrangements of the console assembly 1 at its rear and front end portions 5, 17 have been designed so as not to interfere with the normal attachment and operation of conventional tops such as the soft top 20 in FIGS. 7 and 8. More specifically and as illustrated in FIG. 7, the soft top 20 with its header 22 can be positioned over the console assembly 1 with the header 22 as normally intended abutting the cap or seal 6′ of the upper windshield portion 6. This can be done without any obstruction from the overhead console assembly 1. The soft top 20 in its normal manner can also be latched in place on the upper windshield portion 6 (see FIG. 8) with the hook member 24 of the latch 26 received as designed in the slot 28 of the upper windshield portion 6. The conventional soft top 20 in this regard commonly has a pair of such latches 26 positioned outboard on either side of the elongated console assembly 1 to be received in respective slots 28 in the upper windshield portion 6 (see also FIG. 2).

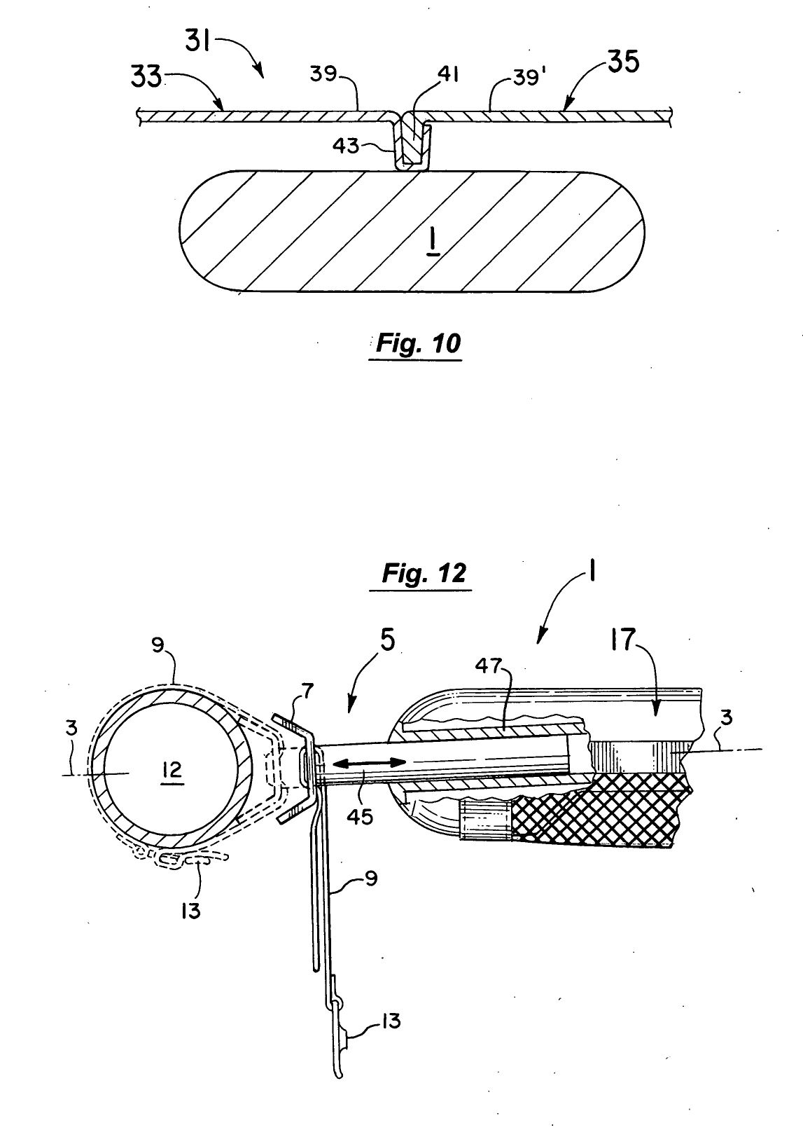

FIGS. 9 and 10 illustrate an embodiment of the present invention in which the elongated console assembly 1 is used with a hardtop 31 that has two, removable sections 33 and 35. Each section 33, 35 preferably has a latch 37 (see FIG. 9) operated essentially in the same manner as the latching mechanism 26 in FIG. 8 to releasably secure each section 33, 35 to the upper windshield portion 6. The inner edge portions 39 and 39′ of the sections 33 and 35 in FIG. 9 can be spaced from one another but preferably have overlapping parts that interlock with one another. As for example and as illustrated in FIG. 10, this can be done using a tongue 41 and groove 43 arrangement. Further and whether or not the edge portions 39,39′ abut or overlap one another, the edge portions 39,39′ are preferably positioned above the console assembly 1 (see again FIG. 10). In this regard, each of the sections 33, 35 is preferably at least partially supported by the console assembly 1. In the illustrated manner of FIG. 10, the grooved section 33 actually abuts the console assembly 1 to be supported directly thereon and the tongued section 35 then rests in the groove 43 of section 33. If the edge portions 39, 39′ are spaced slightly from each other above the console assembly 1, each section 33, 35 would then preferably abut the console assembly 1 at the respective edge portions 39,39′ and be supported directly thereby.

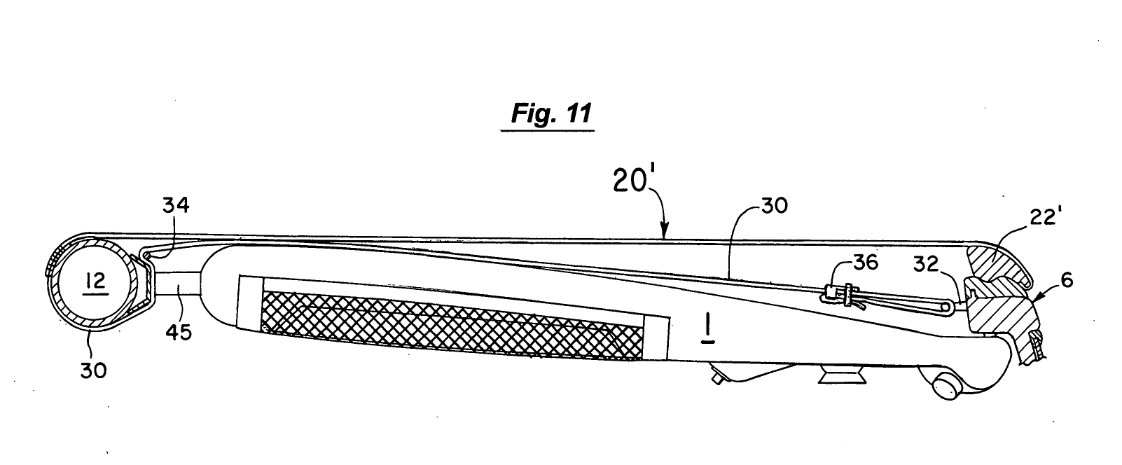

The overhead console assembly 1 of the present invention as discussed above is intended to stay in place whether or not there is a top on the vehicle 2. As also discussed above, a soft top such as 20 in FIGS. 7 and 8 can be closed and opened over the the console assembly 1. The top 20 in this regard can be operated in its normal manner without any interference from the console assembly 1. This is true whether or not the soft top 20 has a header 22 or other convention attaching mechanism to the upper windshield portion 6 such as the belt and channel arrangement of co-owned U.S. Pat. No. 4,757,854. Similarly, full hardtops enclosing the entire interior of the vehicle 2 or a partial hardtop over just the vehicle cockpit as in FIG. 9 can be used with the console assembly 1 of the present invention. The console assembly 1 can also be used with a partial soft top such as 20′ in FIG. 11 that extends over just the cockpit of the vehicle 2. In the arrangement of FIG. 11, the illustrated partial soft top 20′ has a header 22′ like 22 in FIG. 8 latchable to the upper windshield portion 6 in essentially the same manner. Such partial soft tops 20′ commonly have a tie-down strap 30 passing around the safety bar portion 12 and cinched to the footman bracket 32 on the upper windshield portion 6. In adapting the console assembly 1 for use with such a partial soft top 20′, the loop or guide member 34 of FIG. 11 can be provided between the legs 45 (see also FIG. 4) of the rear end portion 5 of the console assembly 1. The tie-down strap 30 can then be routed as shown in FIG. 11 about the safety bar portion 12, up through to be received by the guide member 34, forward about the footman bracket 32, and cinched tight at the buckle 36. The console assembly 1 thus can be used with removable full and partial soft and hard tops that have at least one section selectively positionable over the vehicle cockpit to extend substantially between portions 6 and 12. In each case, the normal operation of the full or partial top (whether a soft top of flexible, foldable material such as vinyl or a hard top of substantially rigid material such as urethane) is not hindered by the console assembly 1 of the present invention.

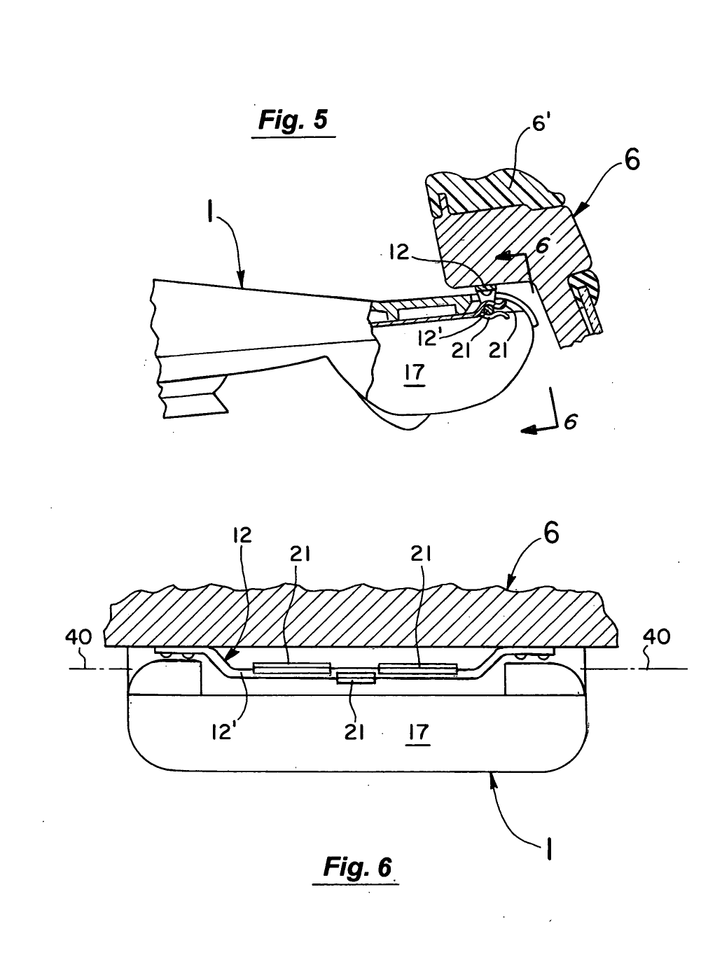

FIG. 12 illustrates a further feature of the present invention in which the rear end portion 5 of the console assembly 1 is mounted for sliding movement relative to the front end portion 17. As previously mentioned, the rear end portion 5 as best seen in FIGS. 4 and 12 has a pair of legs 45 on which the open face member 7 is mounted. Each leg 45 in turn as illustrated in FIG. 12 is slidably received in a channel 47 in the front end portion or section 17 of the console assembly 1 for sliding movement relative thereto along the axis 3. In use, the console assembly 1 is preferably first snapped or clipped onto the footman bracket 12 depending from the upper windshield portion 6 (see FIGS. 5 and 6). The straddling member 7 (FIG. 12) at this point is preferably retracted to the position shown in solid lines in FIG. 12 so the member 7 can be moved or pivoted to align with the level of the safety bar portion 12. The rear end portion 5 and straddling member 7 can thereafter be slid outwardly to the left in FIG. 12 relative to the front end portion 17 to engage the safety bar portion 12 as shown in dotted lines in FIG. 12. The straddling member 7 can then be secured to the safety bar portion 12 by each belted strap 9 as also shown in dotted lines in FIG. 12.

Other advantages of the sliding or telescoping feature of the rear and front end portions or sections 5, 17 of the console assembly 1 also exist. As for example, the console assembly 1 can be adjusted to fit a number of vehicle configurations in which the portions 6 and 12 may be spaced at different distances from each other. The overall length of the console assembly 1 along the axis 3 can thus be quickly and easily adjusted as desired to modify the distance between the end portions 5, 17. Additionally, the pivotal attachment of the front end portion 17 of the console assembly 1 to the upper windshield portion 6 also allows the console assembly 1 to be rotated about the horizontal axis 40 of the rod member 12′ in FIGS. 5 and 6. In this regard, the upper windshield portion 6 and safety bar portion 12 on most vehicle are at substantially the same level or height on the vehicle. However, this may still vary by a few inches or more. Consequently, the pivotally mounted console assembly 1 can be adjusted and positioned to fit between such portions 6 and 12 even though they are not exactly at the same vertical level. In such cases, the portions 6 and 12 are still normally substantially at the same height and the console assembly 1 will still extend substantially horizontally above the vehicle cockpit between the portions 6 and 12 in a convenient overhead manner. Preferably, the axes 8, 14, and 40 are substantially parallel to each other and the axis 3 of the console assembly 1 is substantially perpendicular to them. Consequently, and if the portions 6 and 12 are at slightly different levels, the axis 3 of the console assembly 1 will normally still be perpendicular to the respective axes 8 and 14 of the upper windshield portion 6 and the safety bar portion 12.

With the console assembly 1 in place and whether or not the vehicle 2 has a top, items 42 (e.g., snacks, cell phone, maps) such as illustrated in FIGS. 2 and 3 can be put in the overhead storage compartment 44 and held in place by netting 46 or a lid if desired. Further, the console instruments (e.g., overhead speakers 50, overhead lights 52, and electrical power point 54 in FIG. 4) are always accessible and available for use whether or not the vehicle 2 has a top and whether or not the top is up or down. The console assembly 1 as indicated above can thus be used with essentially any conventional top (full or partial, soft or hard, attached to the vehicle or removable) without any interference of its normal operation by the console assembly 1.

The console assembly 1 as illustrated is preferably secured about midway across or along the respective upper windshield portion 6 and safety bar portion 12. Additionally and although the length of the console assembly 1 is adjustable along the axis 3, the width of the console assembly 1 is preferably substantially uniform along the axis 3. This width in a direction substantially parallel to the axis 8 of the upper windshield portion 6 is preferably a relatively small fraction (e.g., ⅕^{th}) the width or distance the upper windshield portion 6 extends along the axis 8.

While several embodiments of the present invention have been shown and described in detail, it to be understood that various changes and modifications could be made without departing from the scope of the invention.

1. An overhead console assembly for a vehicle, the vehicle having a windshield with an upper portion thereof extending substantially horizontally across the vehicle and a safety bar arrangement with a portion thereof spaced rearwardly of the upper windshield portion and extending substantially horizontally across the vehicle, said upper windshield portion and said safety bar portion being substantially at the same vertical level, said overhead console assembly being respectively mounted to the upper windshield portion and to the safety bar portion to extend therebetween along a first axis,
the vehicle further including a top selectively postionable over the console assembly and extending at least between and over parts of the upper windshield portion and safety bar portion, the vehicle top being a hardtop made of substantially rigid material and including at least one section with an edge portion positionable above the console assembly in an abutting relationship on said console assembly wherein said one section of said hardtop is at least partially supported by said console assembly.

2. The apparatus of claim 1 wherein said upper windshield portion extends along a second axis and said safety bar portion extends along a third axis, said second and third axes being substantially horizontal and further being spaced from each other and substantially parallel to each other.

3. The apparatus of claim 2 wherein the first axis of said overhead console assembly is substantially perpendicular to said first and second axes.

4. The apparatus of claim 1 wherein said upper windshield portion extends along a second axis and said safety bar portion extends along a third axis and said overhead console assembly has first and second end portions spaced from each other along the first axis, said first end portion being secured to the upper windshield portion and said second end portion being secured to said safety bar portion.

5. The apparatus of claim 4 wherein said first end portion of said overhead console is secured to the upper windshield portion substantially midway across the upper windshield portion along the second axis.

6. The apparatus of claim 4 wherein said second end portion of the overhead console assembly is secured to the safety bar portion substantially midway across the safety bar portion along said third axis.

7. The apparatus of claim 4 wherein said first end portion of the overhead console assembly is mounted to said upper windshield portion for pivotal movement relative thereto about a substantially horizontal axis.

8. The apparatus of claim 4 wherein the upper windshield portion includes a rod member and said first end portion of said overhead console assembly is secured to said rod member by a clamping arrangement.

9. The apparatus of claim 4 wherein said second end portion of the overhead console assembly includes a rearwardly facing, open member engaging said safety bar portion and securable thereto.

10. The apparatus of claim 9 wherein said rearwardly facing, open member is securable to said safety bar portions by at least one strap extending about said safety bar portion.

11. The apparatus of claim 1 wherein said overhead console assembly has first and second end portions spaced from each other along the first axis and mounted for movement relative to each other along said first axis between at least two positions to selectively adjust the distance between said first and second end portions.

12. The apparatus of claim 1 wherein the length of said overhead console assembly along said first axis is adjustable.

13. The apparatus of claim 1 wherein the upper windshield portion extends along a second substantially horizontal axis for a first distance and said overhead console assembly has a width in a direction substantially parallel to said second axis, said width being substantially less than said first distance.

14. The apparatus of claim 13 wherein the width of said overhead console assembly is substantially uniform along said first axis.

15. (canceled)

16. The apparatus of claim 1 wherein said top is releasably securable to the upper windshield portion.

17. The apparatus of claim 1 wherein said top is releasably securable to the upper windshield portion by at least one latching mechanism.

18. (canceled)

19. (canceled)

20. (canceled)

21. (canceled)

22. The apparatus of claim 1 wherein said hardtop further includes at least a second section with an edge portion positionable above the console assembly and at least partially supported by said console assembly.

23. The apparatus of claim 22 wherein the edge portions of the first and second sections of the hardtop abut one another over the console assembly.

24. The apparatus of claim 23 wherein parts of said abutting edge portions of the first and second sections of the hardtop overlap one another.

25. The apparatus of claim 24 wherein said overlapping parts of said abutting edge portions interlock with one another.

26. The apparatus of claim 1 wherein said overhead console assembly includes at least one instrument.

27. The apparatus of claim 26 wherein said instrument includes at least one from the group of a speaker, light, and electric power point.

28. The apparatus of claim 1 wherein said overhead console assembly includes at least one storage compartment.
